(19) United States
(12) Patent Application Publication
(10) Pub. No.: US 2007/0223676 A1
(43) Pub. Date: Sep. 27, 2007

(54) Server apparatus

(75) Inventors: Yasumasa Sasaki, Tachikawa-shi (JP); Shigeru Fukazawa, Hachioji-shi (JP); Nobuyuki Takeda, Hachioji-shi (JP); Fumikazu Matsukawa, Ome-shi (JP); Koji Shima, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/717,650

(22) Filed: Mar. 14, 2007

(30) Foreign Application Priority Data
Mar. 24, 2006 (JP) 2006-083313

(51) Int. Cl. H04M 3/42

(52) U.S. Cl. 379/202.01

(57) ABSTRACT

According to one embodiment, a server apparatus includes a controller which selectively executes at least one of first processing of executing communication connections among data terminals to be respectively associated with a plurality of phone IDS included in the call information event, and second processing of making the conference processing unit execute communication-connecting among the data terminals to be respectively associated with the plurality of phone IDs included in the call information event, based on prescribed conditions, when conference connections among the plurality of phone terminals are established.

### CROSS-REFERENCE TO RELATED APPLICATIONS

This application is based upon and claims the benefit of priority from Japanese Patent Application No. 2006-083313, filed Mar. 24, 2006, the entire contents of which are incorporated herein by reference.

### BACKGROUND

1. Field

One embodiment of the invention relates to an improvement of a server apparatus of a visual communication system which connects the server apparatus via a communication line to, for example, a telephone exchange and enables treating a video signal, computer data, etc., in addition to a voice signal.

2. Description of the Related Art

A local area network (LAN) has been used in an office and a business establishment. This LAN system accommodates, for instance, telephone sets as extension terminals into a telephone exchange, such as a private branch exchange (PBX) and a key telephone apparatus, and allows conversations by switch-connecting among the extension terminals and an external communication network, such as a public network, and among mutual extension terminals.

Recently, a system has been proposed, wherein video phone terminals and a server with data terminals, such as personal computers connected thereto, are connected to the telephone exchange via a transmission line then a voice communication system using the telephone exchange and a data communication system using the server work together.

By the way, for such a system given above in which the telephone exchange and the server are arranged in parallel with each other, to constitute a video conference, etc., it is thought that the system utilizes a multi-point control unit (MCU) (for example, Jpn. Pat. Appln. KOKAI Publication No. 2001-268079).

However, the foregoing system does not employ the MCU to a visual communication system (VCS) for making data communication connections among data terminals work together with call states of phone terminals.

In utilizing the MCU, constituting a conference to be used very often by a small-group easily poses a shortage of conference resources of the MCU.

A method for connecting among data terminals in a mesh manner by a VCS server itself being an approach, it is needed to process a plurality of streams by the data terminals as the number of speakers increases, and the system results in having a heavy load.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view depicting a visual communication system regarding a first embodiment of the present invention;

FIG. 2 is an exemplary block diagram depicting a functional configuration of a visual communication system (VCS) server depicted in FIG. 1;

FIG. 3 is an exemplary view depicting an example of storage content of a connection information management table depicted in FIG. 2;

FIG. 4 is an exemplary view depicting an example of storage content of an extension terminal-data terminal (visual communication (VC)) association table depicted in FIG. 2;

FIG. 5 is an exemplary view depicting an example of storage content of a session information management table depicted in FIG. 2;

FIG. 6 is an exemplary view depicting an example of storage content of a number-of-speaker determining table depicted in FIG. 2;

FIG. 7 is an exemplary view depicting an example of storage content of a number-of-MCU-resource determining table depicted in FIG. 2;

FIG. 8 is an exemplary view depicting an example of storage content of a control determining table for each client depicted in FIG. 2;

FIG. 9 is an exemplary sequence view depicting transmitting/receiving operations of information among extension terminals, a main apparatus, a VCS server, and data terminals when conference speech connections are made in the first embodiment;

FIG. 10 is an exemplary flowchart depicting a control procedure of the VCS server when session establishment of the data terminals is accomplished by associating them with the conference speech connections in the first embodiment;

FIG. 11 is an exemplary block diagram depicting a functional configuration of the VCS server as a second embodiment of the invention;

FIG. 12 is an exemplary view depicting an example of storage content of a priority-condition correspondence table depicted in FIG. 11; and

FIG. 13 is an exemplary sequence view depicting transmitting/receiving operations of information among extension terminals, a main apparatus, a VCS server, and data terminals when conference speech connections are made in the second embodiment.

### DETAILED DESCRIPTION

Various embodiments according to the invention will be described hereinafter with reference to the accompanying drawings. In general, according to one embodiment of the invention, a server apparatus which receives a call information event including phone IDs specifying a plurality of phone terminals to be conference-connected from a telephone exchange apparatus, makes communication connections of the plurality of data terminals work together with the conference connections, and is connectable a conference processing unit to execute conference combining processing among the plurality of data terminals, the data terminals being respectively associated with the phone IDs of the plurality of phone terminals, the server apparatus comprising: a controller which selectively executes at least one of first processing of executing communication connections among data terminals to be respectively associated with a plurality of phone IDS included in the call information event, and second processing of making the conference processing unit execute communication-connecting among the data terminals to be respectively associated with the plurality of phone IDs included in the call information event, based on prescribed conditions, when conference connections among the plurality of phone terminals are established.

### First Embodiment

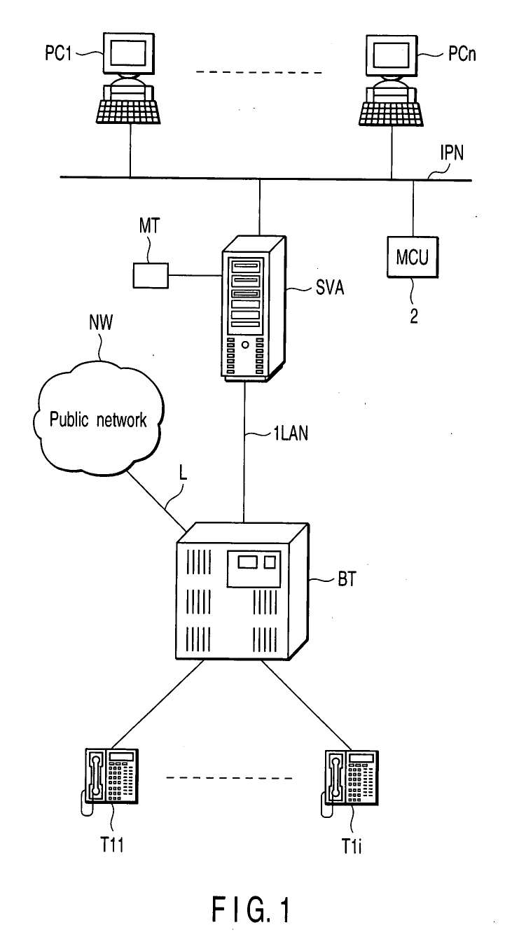

FIG. 1 is a schematic configuration view illustrating a visual communication system regarding a first embodiment of the invention.

The communication system, as shown in FIG. 1, includes a main apparatus BT and a visual communication system (VCS) server SVA, and connects between the main apparatus BT and the VCS server SVA through a local area network (LAN) 1.

The main apparatus BT accommodates extension terminals T11 to T1i via extensions. The main apparatus BT is connected to a public network NW via an office line L. The main apparatus BT executes exchange processing among mutual extension terminals T11 to T1i, or among the extension terminals T11 to T1i and the public network NW.

The VCS server SVA accommodates a plurality of data terminals PC1 to PCn and a multi-point control unit (MCU) 2 as a conference processing unit through an internet protocol (IP) network IPN. Each of these data terminals PC1 to PCn is composed of an all-purpose personal computer (PC), and operates in relation to each extension terminal T11 to T1i, respectively. The MCU 2 performs conference combining processing among the data terminals PC1 to PCn, based on an instruction message and conference control information from the VCS server SVA.

The VCS server SVA executes an additional function to the main apparatus BT, and processes media information of, for instance, a video, etc. Further, a maintenance terminal MT is connected to the VCS server SVA.

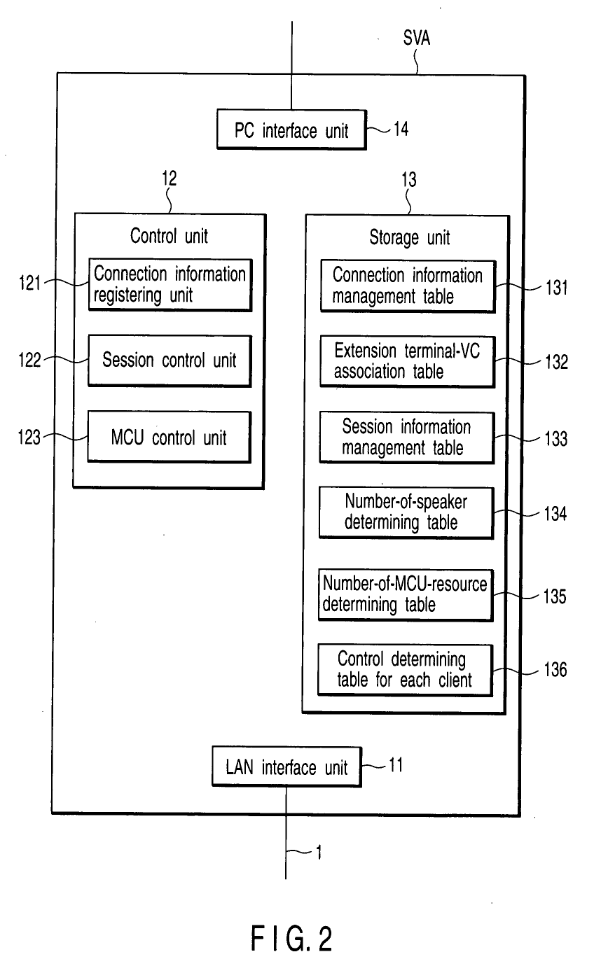

FIG. 2 is a block diagram illustrating a functional configuration of the VCS server SVA.

The VCS server SVA comprises a LAN interface unit 11, a control unit 12, a storage unit 13, and a PC interface unit 14. Among of them, the LAN interface unit 11 conducts interface processing to and from the LAN 1.

The PC interface unit 14 performs interface processing among the data terminals PC1 to PCn.

The storage unit 13 stores routing information, etc., necessary for connection control by the control unit 12. The storage unit 13 further includes a connection information management table 131 (hereinafter referred to as a table 131), an extension terminal-data terminal (VC) association table 132 (hereinafter referred to as a table 132), a session information management table 133 (hereinafter referred to as a table 133), a number-of-speaker determining table 134 (hereinafter referred to as a table 134), a number-of-MCU-resource determining table 135 (hereinafter referred to as a table 135), and a control determining table 136 (hereinafter referred to as a table 136) for each client.

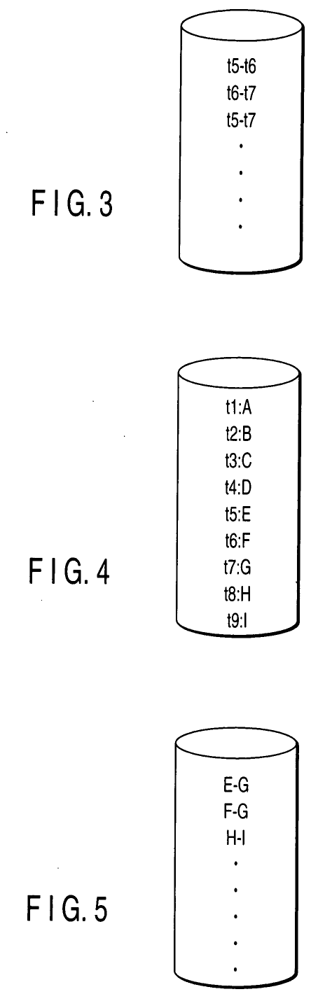

As shown in FIG. 3, the table 131 stores data indicating correspondence relations among each telephone number (phone ID) of the extension terminals T11 to T1i and state information showing connection states. The symbols t1 to t9 indicate each phone ID of the extension terminals T11 to T19, respectively. Here, to simplify a description, the extension terminals T11 to T1i are referred to as extension terminals T11 to T19.

As shown in FIG. 4, the table 132 stores data indicating correspondence relations among the extension terminals T11 to T1i and the data terminal (VC) PC1 to PCn. In FIG. 4, the symbols A to I respectively indicate each user ID of the data terminals PC1 to PC9.

As shown in FIG. 5, the table 133 stores information showing session states among data terminals PC1 to PC9.

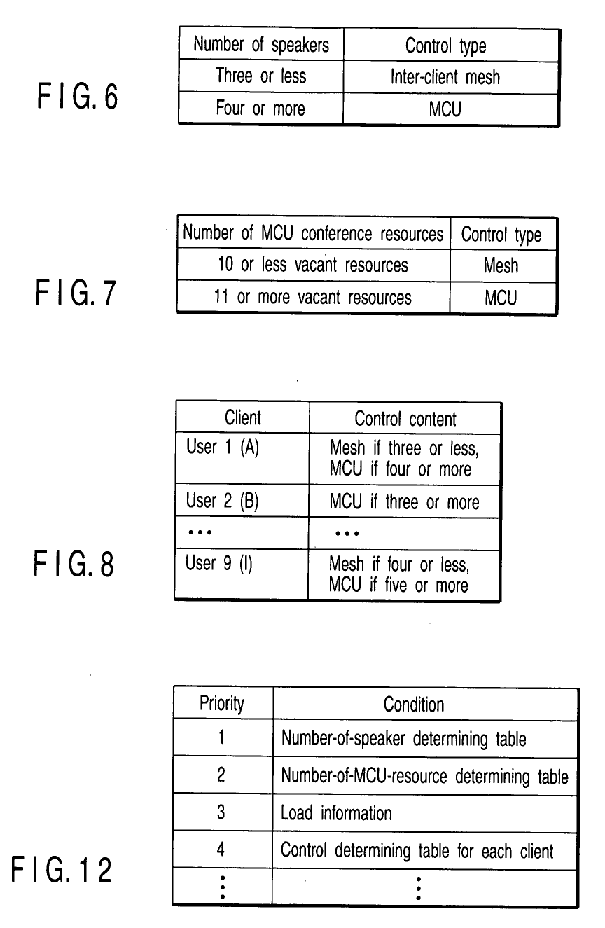

As shown in FIG. 6, the table 134 stores data indicating correspondence relations between the number of speakers and the control types.

As shown in FIG. 7, the table 135 stores data expressing correspondence relations between the number of vacant MCU conference resources and control types.

As shown in FIG. 8, the table 136 stores data indicating correspondence relations among each user ID of the data terminals PC1 to PCn and control content. A maintenance terminal MT connected to the VCS server SV sets the table 134, the table 135, and the table 136.

On the other hand, the control unit 12 comprises a connection information registering unit 121 (hereinafter referred to as a registering unit 121), a session control unit 122, and an MCU control unit 123 as new functions regarding the present invention in addition to a control function related to state management of the data terminals PC1 to PCn and collaborative operations among the data terminals PC1 to PCn and the extension terminals T11 to T1i.

The registering unit 121 analyzes a call information event notified from the main apparatus BT to determine the fact that, for instance, the extension terminal T15 and the extension terminal T16 have been brought into a conversion, and adds state information “t5-t6” of the connection information management table 131.

The Session control unit 122 reads out the fact that the extension terminal T15 is associated with the data terminal PC5 (E), and that the extension terminal T16 is associated with the data terminal PC6 (F) from the table 132 based on the updated state information, and retrieves the session states between the data terminals PC5 and PC6 from the table 133. For instance, when the conversation is started from now, as the data terminals PC5 and PC6 not having started yet, the session control unit 122 controls the beginning of the session so that the data terminals PC5 and PC6 start the session. When the session by the data terminals PC5 and PC6 has established, the session control unit 122 then updates the storage content of the table 133.

In establishing the conference speech connection among the extension terminals T11 to T1i, the MCU control unit 123 refers any one which is set by the maintenance terminal MT out of the table 134, the table 135, and the table 136. Based on the reference result, the MCU control unit 123 selectively executes the processing (mesh inter-client) of the communication connections among the data terminals PC1 to PC9 associated with the plurality of phone IDS, respectively, included in the call information event from the main apparatus BT, and executes the processing (conference combining processing) to communication-connect among the data terminals PC1 to PC9 associated with the plurality of phone IDs, respectively, included in the call information event to the MCU 2. At this moment, when the load information is notified, for example, from the data terminal PC1 so as to establish the session, the MCU control unit 123 executes inter-client mesh. When performing the conference combining processing by the MCU 2, the MCU 123 transmits the conference control information and the session control information as an instruction message to the MCU 2, separately.

Next to this, operations of the visual communication system configured as given above will be described.

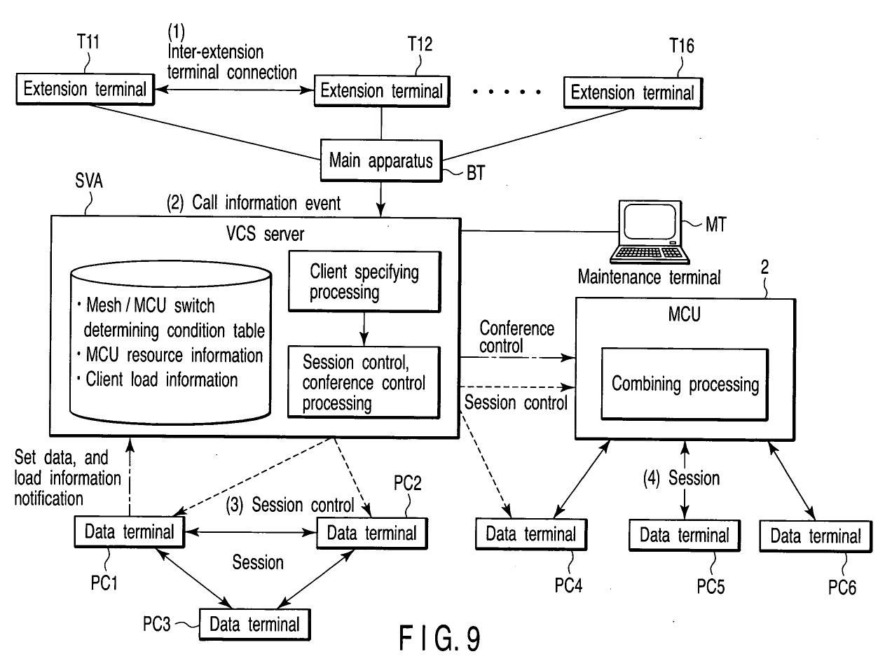

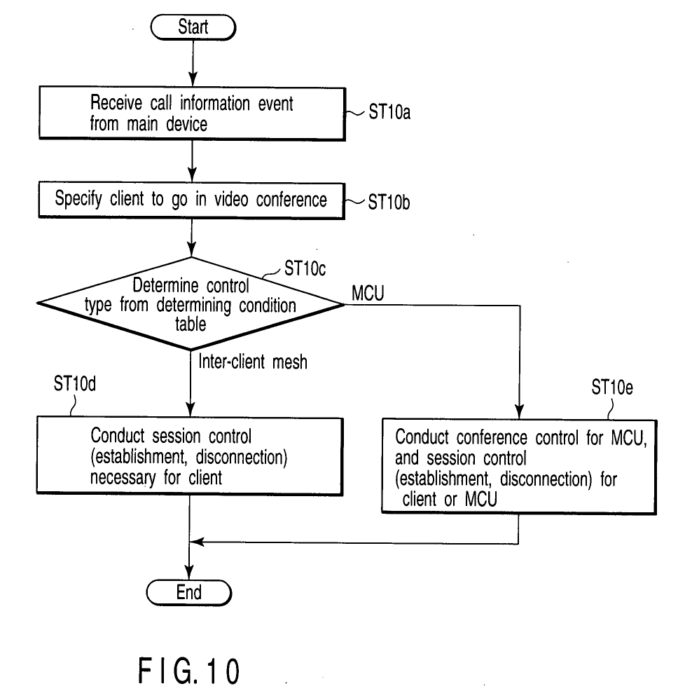

FIG. 9 is a sequence view depicting operations for accomplishing session establishment among each data terminal PC1 to PC6 when the extension terminals T11 to T16 are conference-connected. FIG. 10 is a flowchart illustrating a control processing procedure of the VCS server SVA in accomplishing the foregoing session establishment.

It is assumed that the extension terminals T11 and T12 are in a conversation (FIG. 9(1)).

In such a state, it is supposed that the user of the extension terminal T11 conducts an operation to add the extension terminal T13 to the conference conversation. The extension terminal T11 then transmits its request signal to the main apparatus BT. When receiving the request signal, the main apparatus BT calls out the extension terminal T13 while keeping the communication link between the extension terminal T11 and the extension terminal T12.

When the user of the extension terminal T13 conducts a response operation for the calling, the extension terminal T13 transmits the response signal to the main apparatus BT.

Thus, the system may add the extension terminal T13 to the conference speech between the extension terminals T11 and T12. At this moment, the main apparatus BT detects the fact that a conference has been formed, and transmits the detection result to the VCS server SVA as the call information event (FIG. 9(2)).

When receiving the call information event (block ST10a), the VCS server SVA firstly refers to the table 131 and the table 132 based on the phone ID (t3) included in the call information event. The VCS server SVA specifies the data terminal PC3 to be associated with the extension terminal T13 from the reference result (block ST10b). After this, the VCS server SVA refers to the table 134 to determine whether the session should be accomplished in an inter-client mesh manner or accomplished by using the MCU 2 (block ST10c). The inter-client mesh being employed herein, the VCS server SVA instructs session control necessary for the data terminals T11, T12 and T13 in the same way as that of existing processing (FIG. 9(3), block ST10d).

On the other hand, after adding the extension terminals T14, T15 and T16 to the conference conversations, and when the data terminals PC4, PC5 and PC6 to be associated therewith are specified, the VCS server SVA instructs conference control such as specification of the number of combining speakers and a combining format to the MCU 2, and also performs the session establishment (disconnection) among MCU 2-data terminals PC1 to PC6 by instruction of the session control to the MCU 2 or the data terminal PC1 to PC6 (FIG. 9(4), block ST10e).

If the state before processing is switched from the state that the session has established among the data terminals PC1, PC2 and PC3 to the MCU 2, the VCS server SVA instructs the disconnection of the former session to the corresponding data terminals PC1, PC2 and PC3. The inversion goes same.

It is acceptable that the VCS server SVA arbitrarily receives the load information from the data terminals PC1 to PC9, the VCS server SVA side stores and manages the load information, and conducts the determining processing to make connections in the mesh manner if the load, for instance, on the data terminal PC1 is heavy, based on the load information.

Moreover, the VCS server SVA may determine the mesh or the MCU 2 by taking the combination of the table 134 and the table 135 as the conditions. For instance, the system sets the conditions, such that if the number of the conference speakers is four or more, and also the number of vacant resources of the MCU 2 is ten or more, the VCS server SVA utilizes the MCU 2, and conducts the determination.

As mentioned above, in the first embodiment, when the VCS server SVA executes session establishment control among the plurality of data terminals PC1 to PCn by associating them with the plurality of extension terminals T11 to T1i to be conference-connected, the system executes the session establishment processing among the data terminals PC1 to PCn by sharing the execution with the MCU 2 without relying to the VCS server SVA. For example, if the number of the extension terminals T11 to T1i to be connected to the conference is used as the conditions, up to the three sets of the extension terminals T11, T12 and T13, the inter-client mesh by the VCS server SVA executes the session establishment among the data terminals PC1, PC2 and PC3, and if the data terminal PC4 has been added, the MCU 2 automatically switch the way of the session so as to execute the conference combining processing among the data terminals PC1 to PC4.

Accordingly, the VCS server SVA and the MCU 2 cooperates with each other and efficiently executes the session establishment control among the data terminals PC1 to PCn accompanied by the conference conversation connections among the extension terminals T11 to T1i.

### Second Embodiment

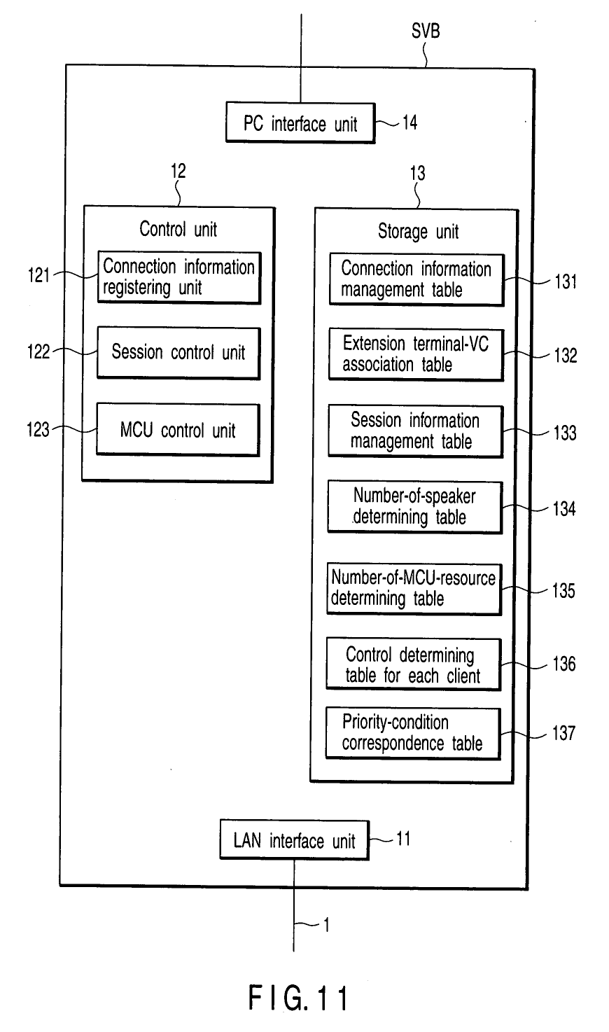

FIG. 11 is a block diagram illustrating a functional configuration of the VCS server SVB as a second embodiment of the present invention. In FIG. 11, the same components as those of FIG. 2 are given the identical symbols and the description will be eliminated.

In the VCS server SVB, the storage unit 13 is provided with a priority-condition correspondence table 137 (hereinafter referred to as a table 137). As shown in FIG. 12, the table 137 stores data showing correspondence relations between priorities and conditions. The maintenance terminal MT connected to the VCS server SVB sets the table 137.

When the conference conversation connections among the extension terminals T11 to T1i are established, the MCU control unit 123 refers to the table 137, and selects the table 134 with a high priority from the result of the reference. The MCU control unit 123 selectively executes the processing to communication-connect among the data terminals PC1 to PC9 to be respectively associated with each of the plurality of phone IDs included in the call information event from the main apparatus BT (inter client mesh), and executes the processing to communication-connect among the data terminals PC1 to PC9 to be respectively associated with each of the plurality of phone IDs included on the call information event (conference combining processing). At this moment, to execute the conference combining processing through the MCU 2, the MCU control unit 123 inserts the conference control information into an instruction message to transmit it to the MCU 2.

The following will be set forth operations of the visual communication system configured as mentioned above.

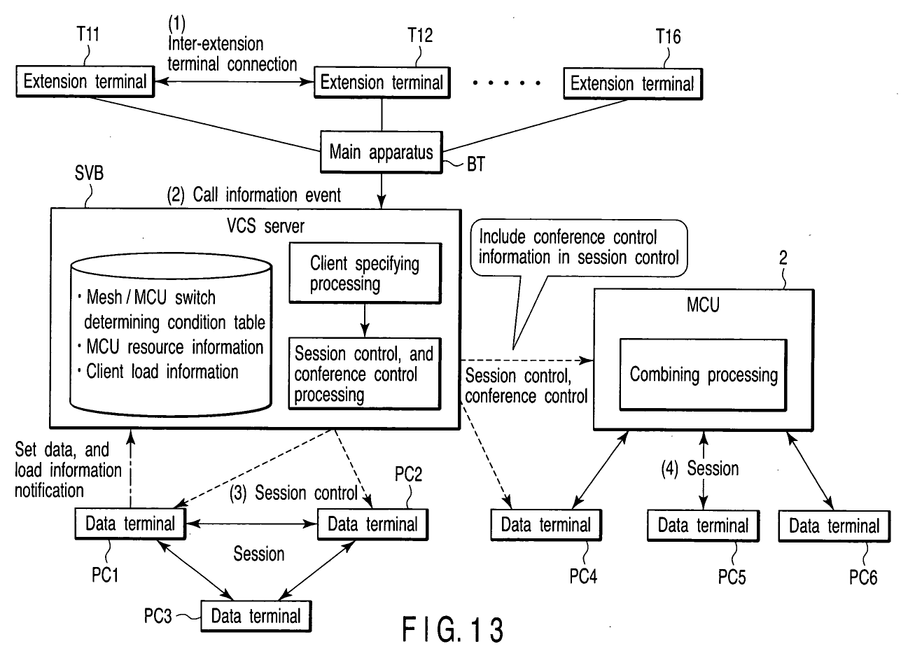

FIG. 13 is a sequence view illustrating operations for accomplishing session establishment among each data terminal PC1 to PC6 when the extension terminals T11 to T16 are conference-connected.

It is assumed that the extension terminals T11 and T12 have being in a conversation with each other (FIG. 13(1)).

In such a state, it is supposed that the user of the extension terminal T11 conducts an operation to add the extension terminal T13 to the conference conversation. The extension terminal T11 then transmits its request signal to the main apparatus BT. When receiving the request signal, the main apparatus BT calls out the extension terminal T13 while keeping the communication link between the extension terminal T11 and the extension terminal T12.

When the user of the extension terminal T13 conducts a response operation for the calling, the extension terminal T13 transmits the response signal to the main apparatus BT.

Thus, the system may add the extension terminal T13 to the conference conversation which has been made between the extension terminals T11 and T12. At this moment, the main apparatus BT detects the fact that a conference has been formed and transmits the detection result to the VCS server SVB as the call information event (FIG. 13(2)).

When receiving the call information event, the VCS server SVB firstly refers to the table 131 and the table 132 based on the phone ID (t3) included in the call information event, and specifies the data terminal PC3 to be associated with the extension terminal T13 from the reference result. After this, the VCS server SVB refers to the table 137 to select the table 134 from the reference result, and determines which of the inter-client mesh-type session or the MCU 2-used session should be executed. The inter-client mesh being used herein, the VCS server SVB instructs session control necessary for the data terminals T11, T12 and T13 in the same way as that of the existing processing (FIG. 13(3)).

On the other hand, after adding the extension terminals T14, T15 and T16 to the conference conversation, and when the data terminals PC4, PC5 and PC6 to be associated with the extension terminals T14, T15 and T16 are specified, the VCS server SVB integrally instructs conference control such as the specification of the number of the combining speakers and a combining format, and the session control to the MCU 2. Then, the VCS server SVB performs the session establishment (disconnection) among MCU 2 and data terminals PC1 to PC6 (FIG. 13(4)).

As mentioned above, in the second embodiment, when the VCS server SVB executes the session establishment control among the plurality of data terminals PC1 to PC6 by associating them with the plurality of extension terminals T11 to T1i to be connected for conference-speech, a plurality items of condition information pre-registered in the table 137 is selected in priority order.

Therefore, in the case where the number of speakers and the number of conference resources are employed as the conditions, if there is any vacant resource, the pre-registered conditions are preferentially determined. So that, even if the system is in any situation, the VCS server SVB and the MCU 2 may respond relatively flexibly, and efficiently perform the session establishment control among the data terminals PC1 to PCn to be associated with the extension terminals T11 to T1i which are brought in the conference speech connections.

In the second embodiment, the VCS server SVB inserts conference control information into the existing instruction message, such as a “NOTIFY” message defined by a session initiation protocol (SIP), to transmit it, and makes the MCU 2 execute the conference combining processing among the data terminals PC1 to PCn. Therefore, a simple procedure enables executing the conference combining processing among the data terminals PC1 to PCn.

### Other Embodiment

The present invention is not limited to the aforementioned each embodiment. For instance, in the first and the second embodiment, as for the conditions to switch between the conference combining processing by the inter-client mesh and the combining processing by the MCU 2, examples, in which the number-of-speaker determining table, the number-of-MCU-resource determining table, the control determining table for each client, and the load information from the data terminals are used, have described. However, the invention is not limited to the examples, and various conditions may be usable.

In each of the embodiments, examples separately provided with the main apparatus and the VCS server having described, it is also acceptable to install the function of the main apparatus into the VCS server.

Other than this, also as for the configuration and the type of the VCS server, the type of the telephone exchange (not limited to main apparatus but PBX is acceptable), the type of the extension terminal, the type of the data terminal, the storage contents of various tables, the method for associating with the data terminals in the conference speech connection, and the like, this invention may be embodied in various forms without departing from the sprit or scope of the inventive concept thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as world fall within the scope and spirit of the inventions.

What is claimed is:

1. A server apparatus which receives a call information event including phone IDs specifying a plurality of phone terminals to be conference-connected from a telephone exchange apparatus, makes communication connections of the plurality of data terminals work together with the conference connections, and is connectable a conference processing unit to execute conference combining processing among the plurality of data terminals, the data terminals being respectively associated with the phone IDs of the plurality of phone terminals, the server apparatus comprising:
a controller which selectively executes at least one of first processing of executing communication connections among data terminals to be respectively associated with a plurality of phone IDS included in the call information event, and second processing of making the conference processing unit execute communication-connecting among the data terminals to be respectively associated with the plurality of phone IDs included in the call information event, based on prescribed conditions, when conference connections among the plurality of phone terminals are established.

2. The server apparatus according to claim 1, wherein the controller uses for determining the conditions at least one of the number of the phone terminals to be conference-connected, the number of vacant conference resources to connect a plurality of data terminals in the conference processing unit thereto, contents preset for each user of the data terminals, and each load situation of the plurality of data terminals.

3. The server apparatus according to claim 1, wherein the controller uses for determining the conditions arbitrary combinations of the number of the phone terminals to be conference-connected, the number of vacant conference resources to connect a plurality of data terminals in the conference processing unit thereto, contents preset for each user of the data terminals, and each load situation of the plurality of data terminals.

4. The server apparatus according to claim 1, further comprising a memory which stores a table in which information, showing, as the conditions, the number of the phone terminals to be conference-connected, the number of vacant conference resources to connect a plurality of data terminals in the conference processing unit thereto, contents preset for each user of the data terminals, and each load situation of the plurality of data terminals, is associated in priority order, wherein
the controller selectively executes the first and the second processing based on the priority order in the table.

5. The server apparatus according to claim 1, wherein the controller inserts conference control information necessary for conference combining processing among the plurality of data terminals into an instruction message to transmit the instruction message and the control information to the conference processing unit in executing the second processing.

6. The server apparatus according to claim 1, wherein the controller separately transmits an instruction message and conference control information necessary for conference combining processing among the plurality of data terminals to transmit them to the conference processing unit in executing the second processing.
